(19) United States
(12) Patent Application Publication
(10) Pub. No.: US 2009/0082942 A1
(43) Pub. Date: Mar. 26, 2009

(54) APPARATUS FOR AND METHOD OF CONTROLLING FUEL INJECTION OF INTERNAL COMBUSTION ENGINE

(75) Inventors: Masanobu Ohsaki, Isesaki-shi (JP); Masami Nagano, Isesaki-shi (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/210,444

(22) Filed: Sep. 15, 2008

(30) Foreign Application Priority Data
Sep. 20, 2007 (JP) 2007-243909

(51) Int. Cl. F02D 41/30

(52) U.S. Cl. 701/103

(57) ABSTRACT

A first fuel injection valve is arranged in an intake port of an internal combustion engine and also a second fuel injection valve capable of exhibiting a spray property having a vaporization characteristic higher than that of the first fuel injection valve is arranged on the intake air flow downstream side of the first fuel injection valve, the fuel injection is performed by the second fuel injection valve at a cranking time, and after a predetermined time has elapsed from completion of the cranking, the share for the first fuel injection is gradually increased to thereby change-over the fuel injection to that by the first fuel injection valve. Further, at a time of the engine acceleration, a main fuel injection amount is injected by the first fuel injection valve and a fuel injection amount equivalent to an increasing amount for acceleration is injected by the second fuel injection, thereby eventually improving the fuel consumption as well as the exhausting performance.

### BACKGROUND OF THE INVENTION

1. Field of the Invention

The present invention generally relates to an apparatus for and a method of controlling fuel injection of an internal combustion engine, and in particular, to a technique for disposing fuel injection valves which are different in respective spray properties to achieve an improvement in air-fuel mixture properties within an internal combustion engine.

2. Description of the Related Art

Japanese Laid-open (Kokai) Patent Application Publication No. 2003-269222 discloses a fuel injection controlling apparatus provided with a first fuel injection valve which injects fuel of relatively large atomized particle size is arranged on the upstream side of an intake passage, and a second fuel injection valve which injects fuel of relatively small atomized particle size is arranged on the downstream side of the intake passage. Thus, according to the disclosure of the above published document, the fuel injection controlling apparatus operates in a manner such that, at starting of an engine operation, i.e., at a time of engine cranking, the fuel in a small atomized particle size state is injected from the second fuel injection valve, and after completion of the starting of the engine operation, the fuel injection by the second fuel injection valve is changed-over to that by the first fuel injection valve, based on parameters of an intake pipe pressure, an engine rotating speed and the like, to reduce a wall flow rate of the air-fuel mixture to thereby improve the fuel consumption and the exhausting performance of the internal combustion engine.

However, according to the above-described controlling apparatus of the above published document, when the fuel injection by the second fuel injection valve is changed-over to that by the first fuel injection valve, the operation to perform the changing-over is controlled in an ON/OFF manner by setting a flag. Therefore, since a vaporization characteristic of fuel spray from the first fuel injection valve is different from that of the second fuel injection valve, there is a possibility of occurrence of step-like difference in a torque that is outputted as well as an air-fuel ratio of the fuel-air mixture that is injected into the internal combustion engine, and as a result, the operability or the exhausting performance at the changing-over time might often be degraded.

### SUMMARY OF THE INVENTION

In view of the above problems, an object of the present invention is to properly control fuel injection valves which are mutually different in their atomizing performances, for the purpose of preventing occurrence of a torque difference in step as well as an air-fuel ratio difference in step when the fuel injection valves are changed-over, thereby eventually preventing or suppressing the operability degradation or the exhausting performance degradation.

In order to achieve the above object, according to the present invention, such a contrivance is adopted that (1) a first fuel injection valve having a predetermined spraying property is disposed on an intake port while allowing a second fuel injection valve having a different spraying property in which a vaporization characteristic is higher than that performed by the first fuel injection valve to be disposed on an upstream side of the first fuel injection valve, (2) detection of an engine operating state is implemented while allowing a control unit to set a fuel injection amount, based on the detected engine operating state and to control the fuel injection valves performing the fuel injection according to the set fuel injection amount, and (3) when it is detected a state that the fuel is to be injected simultaneously by both the fuel injection valves, setting of fuel injection amounts to be respectively shared by these fuel injection valves is implemented so as to eventually control the above-mentioned fuel injection valves according to the set fuel injection amounts.

The other objects and features of this invention will become understood from the following description with reference to the accompanying drawings.

### BRIEF DESCRIPTION OF THE DRAWINGS

FIG. 1 is a schematically diagrammatic view illustrating a system configuration according to the present invention;

FIG. 2 is a graphical view indicating a relationship between fuel injection amounts of fuel injection valves (the abscissa) and an average particle size of fuel spray (the ordinate);

FIG. 3 is a former stage of a flowchart of fuel injection control in a first embodiment;

FIG. 4 is a latter stage of the flowchart of fuel injection control of the first embodiment;

FIG. 5 is a former stage of a flowchart of fuel injection control of a second embodiment;

FIG. 6 is a latter stage of the flowchart of fuel injection control of the second embodiment;

FIG. 7 is a flowchart of fuel injection control in a third embodiment;

FIG. 8 is a flowchart of fuel injection control in a fourth embodiment;

FIG. 9 is a flowchart of fuel injection control in a fifth embodiment;

FIG. 10 is a former half stage of a flowchart of fuel injection control of a sixth embodiment;

FIG. 11 is a latter half stage of the flowchart of fuel injection control of the sixth embodiment;

FIG. 12 is a time chart indicating the time sequence in the fuel injection control of the sixth embodiment;

FIG. 13 is a former half stage of a flowchart of fuel injection control of a seventh embodiment;

FIG. 14 is a latter half stage of the flowchart of fuel injection control of the seventh embodiment; and

FIG. 15 is a schematically diagrammatic view illustrating another system configuration according to the present invention.

### DESCRIPTION OF PREFERRED EMBODIMENTS

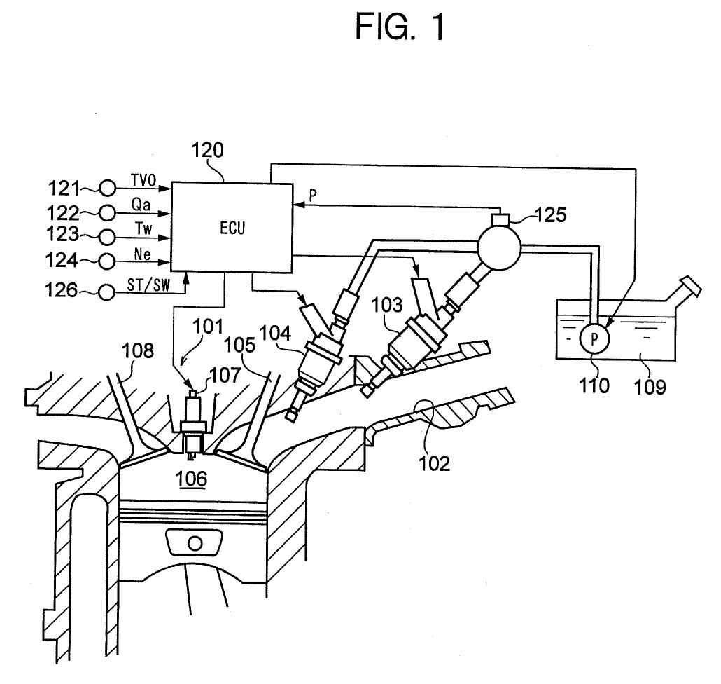

FIG. 1 shows one typical embodiment of the entire system configuration of an internal combustion engine according to the present invention.

Referring to FIG. 1, an internal combustion engine generally denoted by 101 is provided with a first fuel injection valve 103 having a maximum injection amount that is relatively large, which is disposed on the upstream side of an intake port 102, and a second fuel injection valve 104 having a maximum injection amount that is relatively small, which is disposed at a position on a downstream side and closer to a cylinder.

Each of first and second fuel injection valves 103 and 104 is an electromagnetic type fuel injection valve which is opened by lifting up a valve body due to a magnetic suction force of an electromagnetic coil. Second fuel injection valve 104 of small maximum injection amount has a nozzle hole smaller than that of first fuel injection valve 103 of large maximum injection amount, and therefore, fuel atomization is promoted, so that atomized particle size is small and a vaporization characteristic of fuel spray is high.

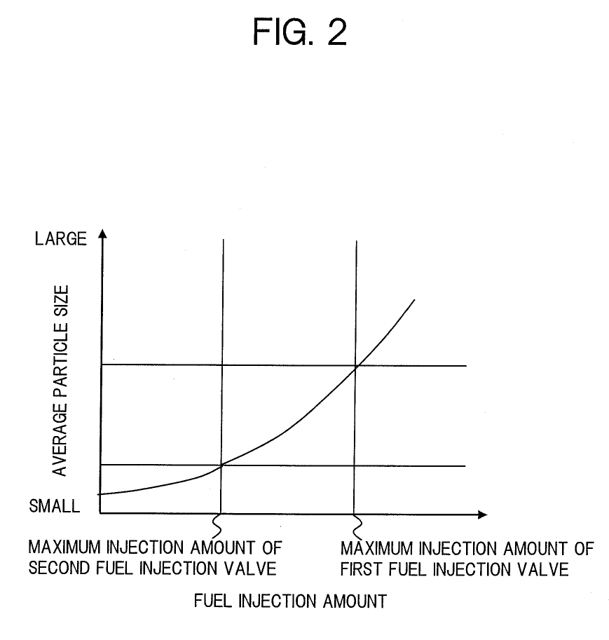

FIG. 2 indicates a relationship between the fuel injection amounts and an average particle size of fuel spray.

Each of first and second fuel injection valves 103 and 104 is driven to open in an intake stroke at which an intake valve 105 is opened, to inject fuel, and the injected fuel and the air are sucked into a combustion chamber 106.

Air-fuel mixture in combustion chamber 106 is combusted by spark ignition by an ignition plug 107, and the combusted exhaust gas is discharged via an exhaust valve 108.

Fuel (gasoline) in a fuel tank 109 is pumped by a fuel pump 110 to be sent to first and second fuel injection valves 103 and 104, respectively. A supply pressure of the fuel is controlled at a target pressure by controlling a discharge amount of fuel pump 110.

A control unit (ECU) 120, which incorporates therein an electronic microcomputer, is provided to control first and second fuel injection valves 103 and 104, ignition plug 107, fuel pump 109 and the like, based on detection signals inputted from various sensors which detect operating state of engine 101.

As the various sensors, there are disposed a throttle sensor 121 for detecting an opening TVO of a throttle valve (not shown in the figure) disposed in an intake passage of engine 101, an air flow meter 122 for detecting an intake air amount Qa of engine 101, a water temperature sensor 123 for detecting the cooling water temperature TW of engine 101, a rotating speed sensor 124 for detecting an engine rotating speed Ne, a fuel pressure sensor 125 for detecting a fuel pressure, a starter switch 126 for detecting ON/OFF of a starter, and the like.

In such a system configuration, first and second fuel injection valves 103 and 104 are controlled, while deciding whether first fuel injection valve 103 or second fuel injection valve 104 is to perform the fuel injection, based on the engine operating state captured by the above-described various signals of detection.

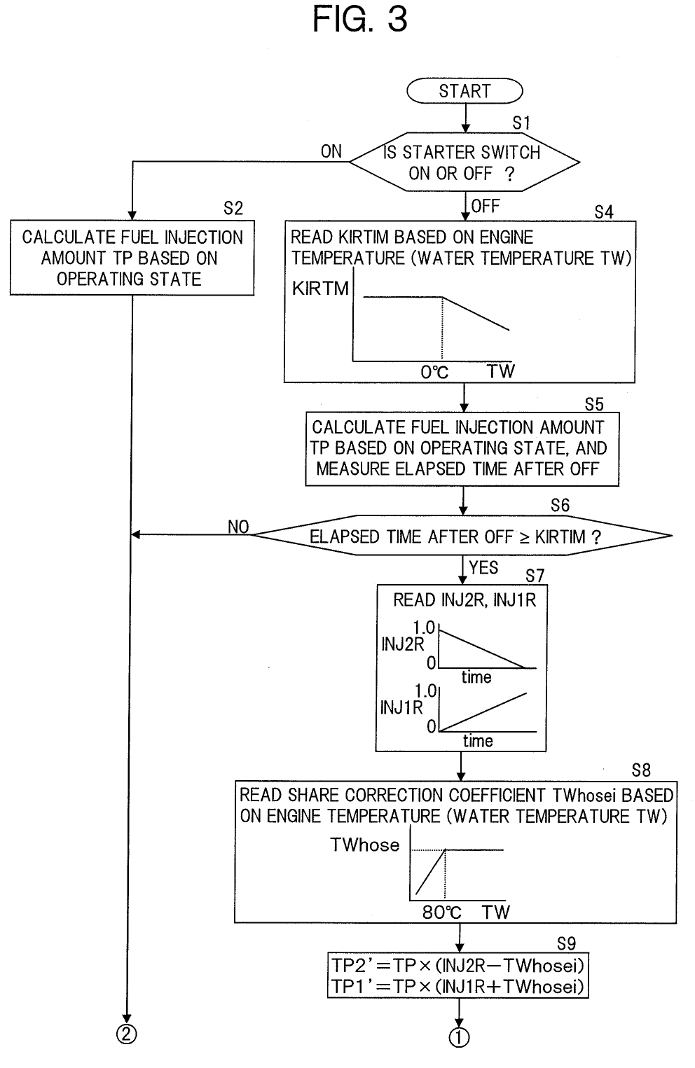

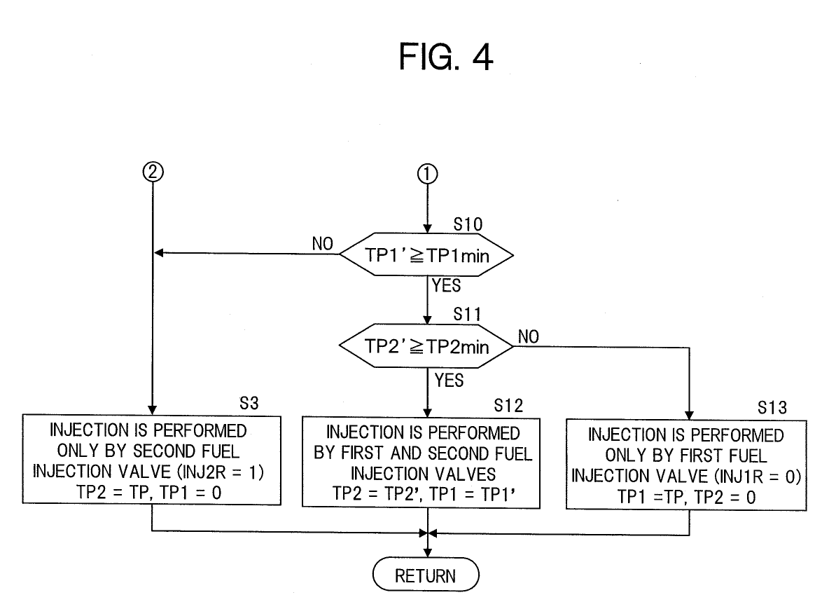

After the completion of starting of an engine operation from the time of starting of the engine operation, the fuel injection valve which is to perform the fuel injection is changed-over from second fuel injection valve 104 to first fuel injection valve 103. This fuel injection control in a first embodiment will be described hereinbelow, in accordance with a flowchart in FIG. 3 and FIG. 4. This flowchart is activated when starter switch (ST/SW) 126 is turned ON.

In step S1, it is judged whether or not starter switch 126 is turned ON, that is, whether or not the engine is in cranking operation.

If it is judged that the engine is in cranking operation, the control process proceeds to step S2 where a fuel injection amount TP for cranking is calculated based on the water temperature TW and the like.

In step S3, it is decided that the driving of first fuel injection valve 103 is stopped, and only second fuel injection valve 104 is to be driven to perform the fuel injection (the share INJ2R of second fuel injection valve 104=1.0). Namely, a fuel injection amount TP2 of second fuel injection valve 104 is made equal to the fuel injection amount TP, and the fuel injection amount TP1 of first fuel injection valve 102 is set to 0.

Consequently, at the time of engine cranking, the fuel of the fuel injection amount TP is injected by second fuel injection valve 104, so that the engine operation is started.

In step S1, when it is judged that starter switch 126 is turned from ON to OFF, that is, for a while after the starting of the engine operation that takes place by the completion of the cranking, the fuel injection by second fuel injection valve 104 is continued to ensure the engine operation stability, and thereafter, the fuel injection by second fuel injection valve 104 is changed-over to that by first fuel injection valve 103.

After the starting of the changing-over control, the fuel injection amount of first fuel injection valve 103 is gradually increased while gradually decreasing the fuel injection amount of second fuel injection valve 104, so that the fuel injection is finally changed-over to that only by first fuel injection valve 103, while maintaining a total fuel injection amount at a required amount.

Firstly, in step S4, a predetermined time KIRTIM as a threshold for judging start timing of changing-over of the fuel injection valves is calculated based on a characteristic map (shown in the figure), depending on an elapsed time after the cranking is finished (to be described below), based on the engine temperature (cooling water temperature TW).

The predetermined time KIRTIM is set at a time sufficient for the stability of combustion and rotation of the engine after the cranking is completed. In the below-freezing temperature, since a time required for the stability of combustion and rotation is long, the predetermined time KIRTIM is set to be fixed at a long time so that the continuation of fuel injection by second fuel injection valve 104 is lengthened. Whereas, in the above-freezing temperature, the predetermined time KIRTIM is set to be decreased according to the temperature rise.

In step S5, the fuel injection amount TP is calculated based on the engine operation state, and also, an elapsed time from a time when starter switch 126 is turned OFF is measured.

To be specific, the fuel injection amount TP is calculated by correcting a basic fuel injection amount TP0 calculated based on an intake air amount Qa1 detected by air flow meter 122 and the engine rotating speed Ne detected by rotating speed sensor 124 with an air-fuel ratio feedback correction coefficient, which is set based on an air-fuel ratio detection value from an air-fuel ratio sensor (not shown in the figure), and the like.

In step S6, it is judged whether or not the elapsed time reaches the predetermined time KIRTIM. In place of the predetermined time KIRTIM, the elapsed time may be judged based on whether or not the fuel injection number of times after the cranking is completed reaches the predetermined number of times.

Until the elapsed time reaches the predetermined time KIRTIM, the control process proceeds to step S3 where the fuel injection only by second fuel injection valve 104 is continued, and when it is judged that the elapsed time reaches the predetermined time KIRTIM, the control process proceeds to step S7 and the subsequent steps where the fuel injection starts to be changed-over from second fuel injection valve 104 to first fuel injection valve 103.

In step S7, the share INJ2R of second fuel injection valve 104 and the share INJ1R of first fuel injection valve 103, which are set according to an increase of an elapsed time from the changing-over starting, are set based on a characteristic map (shown in the figure).

The fuel injection is smoothly changed-over such that the share INJ2R of second fuel injection valve 104 is gradually decreased from 1.0 before the changing-over to reach 0, whereas the share INJ1R of first fuel injection valve 103 is gradually increased from 0 to reach 1.

In step S8, at a transition time of changing-over of the fuel injection from second fuel injection valve 104 to first fuel injection valve 103, a share correction coefficient TWhosei for correcting the shares of the injection amounts of respective fuel injection valves for a case where the fuel injection is performed by respective fuel injection valves (it may be referred to as a double injection period) based on the engine temperature (water temperature TW), is calculated from a characteristic map (shown in the figure) based on the water temperature TW.

The share correction coefficient TWhosei (≦1) is set such that as a value thereof becomes smaller, the share of first fuel injection valve 103 becomes smaller and the share of second fuel injection valve 104 becomes larger. Before the completion of warming-up operation (lower than 80° C.), since the combustion is stagnant to become stable for the reason that the water temperature is lower, the share correction coefficient TWhosei is set to be smaller, so that the double fuel injection period is made longer.

In step S9, a fuel injection amount TP2′ of second fuel injection valve 104 and a fuel injection amount TP1′ of first fuel injection valve 103 are calculated in accordance with the next formulas, based on the share INJ2R of second fuel injection valve 104, the share INJ1R of first fuel injection valve 103 and the share correction coefficient TWhosei.

TP2′=TP×(INJ2R−TWhosei)

TP1′=TP×(INJ1R+TWhosei)

In the above formulas, TP=TP1′+TP2′ is maintained provided that INJ1R+INJ2R=1.

The correction based on the engine temperature is not limited to the above, and if inclinations of INJ2R and INJ1R shown in step S7 are corrected to be smaller as the engine temperature is lower, the double fuel injection period can be lengthened.

For the simplicity, there may be an embodiment in which the process is terminated at this point, and TP1′ and TP2′ are directly used as TP1 and TP2 to drive first fuel injection valve 103 and second fuel injection valve 104.

However, regarding the electromagnetically driven type fuel injection valve, in a small injection amount region less than a predetermined injection amount region, the linearity between injection pulse width (ON time) and an injection amount is degraded, and accordingly, a stable injection amount characteristic cannot be obtained. Therefore, in the flowchart of the present embodiment, the fuel injection in the small injection amount region where the stable injection amount characteristic cannot be obtained is inhibited.

In step S10, it is judged whether or not the calculated TP1′ is equal to or larger than a lower limit injection amount TP1min at which the stable injection amount characteristic (linearity of injection amount relative to ON time) of first fuel injection valve 103 can be maintained.

While the calculated TP1′ is judged to be smaller than the lower limit injection amount TP1min immediately after the changing-over starting, the control process proceeds to step S3 where the fuel injection only by second fuel injection valve 104 is continued (it is judged that the fuel injection valve to perform the fuel injection is only second fuel injection valve 104).

When it is judged that TP1′ calculated in step S7 is equal to or larger than TP1min as a result that the share of first fuel injection valve 103 is increased with the time lapse, the control process proceeds to step S11 where it is judged whether or not the calculated TP2′ is equal to or larger than a lower limit injection amount TP2min at which the stable injection amount characteristic of second fuel injection valve 104 can be maintained.

Then, while TP2′ is maintained to be equal to or larger than TP2min, the control process proceeds to step S12 where TP1′ and TP2′ are used as TP1 and TP2, and first and second fuel injection valves 103 and 104 are driven to perform the respective fuel injection (it is decided that the fuel injection valves to perform the fuel injection are first and second fuel injection valves 103 and 104).

When it is judged in step S11 that TP2′ is smaller than TP2min as a result that the share of second fuel injection valve 104 is decreased with the further time lapse, the control process proceeds to step S13 where the fuel injection from second fuel injection valve 104 is stopped provided that TP2=0, and the fuel injection is performed only by first fuel injection valve 103 provided that TP1=TP (it is decided that the fuel injection valve to perform the fuel injection is only first fuel injection valve 103).

Thus, the configuration is such that when the fuel injection from second fuel injection valve 104 is changed-over to first fuel injection valve 103, the double injection period is set, and during the double injection period, the fuel injection is smoothly changed-over while gradually changing the shares of the respective fuel injection valves. Therefore, a torque difference or an air-fuel ratio difference due to an atomizing performance difference can be prevented, and furthermore, the operability degradation or the exhausting performance degradation can be suppressed.

Further, at the cranking time and during a period until the predetermined time KIRTIM is elapsed so that the combustion and the rotation are stabilized after the cranking is finished, the fuel injection is performed only by second fuel injection valve 104 having the favorable fuel vaporization characteristic.

Furthermore, the predetermined time KIRTIM is set according to the engine temperature (water temperature TW) and the shares are set with the share correction coefficient TWhosei, so that the further proper changing-over control can be performed according to the vaporization characteristic due to the engine temperature.

In detail, as the engine temperature (water temperature and the like) is lower, the time required for the stabilization of combustion and rotation is increased. Therefore, the predetermined time KIRTIM is set to be larger, and after the cranking is finished, the fuel injection by second fuel injection valve 104 is continued longer, and thereafter, the fuel injection starts to be changed-over to first fuel injection valve 103, so that the stability of combustion and rotation can be ensured. Further, as the combustion is also hard to be stabilized as the engine temperature is lower, and therefore, the double injection period is lengthened by correcting the shares with the share correction coefficient TWhosei, so that the stability of combustion can be maintained.

However, for the simplicity, the predetermined time KIRTIM may be set as a fixed value or the correction with the share correction coefficient TWhosei may be omitted.

Still further, the respective fuel injection valves are made to perform the fuel injection in the regions equal to or larger than the lower limit injection amounts TP1min and TP2min, where the stable injection amount characteristics (the linearity of injection amount relative to the ON time) can be maintained. Therefore, the fuel injection amount can always be controlled with high precision, and the operability, the exhausting performance and the like are further improved.

Second fuel injection valve 104 is disposed on intake port 102 at the site closer to a cylinder. Therefore, when the fuel is injected in the intake stroke at which intake valve 105 is opened, since most of the vaporization promoted fuel is directly flown into combustion chamber 106 while avoiding the attachment to intake port 102 or intake valve 105, a surplus fuel injection amount can be sufficiently decreased.

Accordingly, it is possible to improve the fuel consumption while ensuring the good starting performance, and to decrease a discharge amount of unburned fuel.

After the stable combustion and the stable rotation are obtained as in the above manner, the fuel injection is changed-over to first fuel injection valve 103, to thereby ensure the required fuel injection amount.

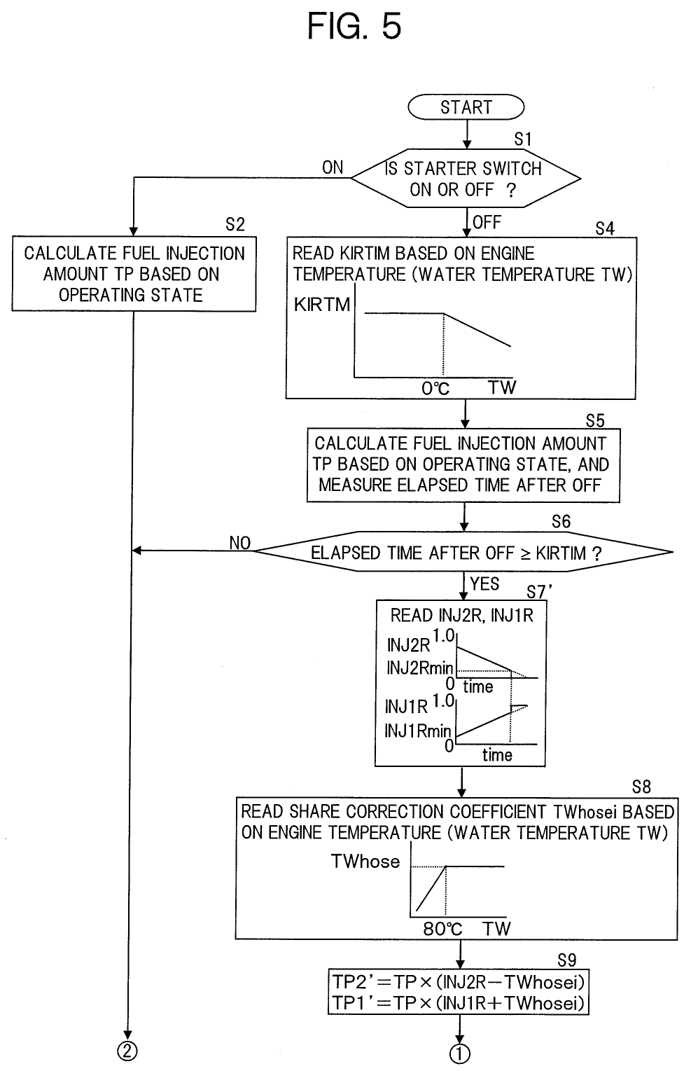

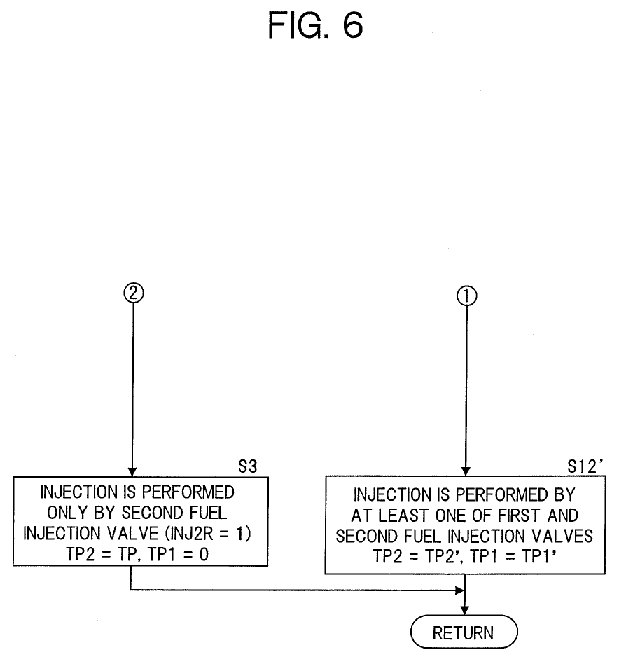

FIGS. 5 and 6 show a flowchart of a second embodiment further simplifying the configuration in which the fuel injection is inhibited in the small injection amount region where the stable injection amount characteristic cannot be obtained, compared with the flowchart of FIG. 3.

In step S7′ of FIG. 5, the share INJ1R of first fuel injection valve 103 and the share INJ2R of second fuel injection valve 104 are respectively set to be maintained equal to or larger than a lower limit share INJ1Rmin and a lower limit share INJ2Rmin, at which the stable injection amounts can be ensured. Incidentally, the shares INJ1R and INJ2R are set taking the correction with the share correction coefficient TWhosei in step S9 into consideration. Further, differently from step S7 of FIG. 3, the fuel injection is shared to be performed by first fuel injection valve 103 from the starting time of changing-over of the fuel injection. Therefore, the predetermined time KIRTIM for judging the elapsed time after the cranking is finished in step S5 may be set to be longer.

Thus, the injection amounts TP1 and TP2 calculated in step S7′ may be directly used, and therefore, the judgment thereafter is unnecessary.

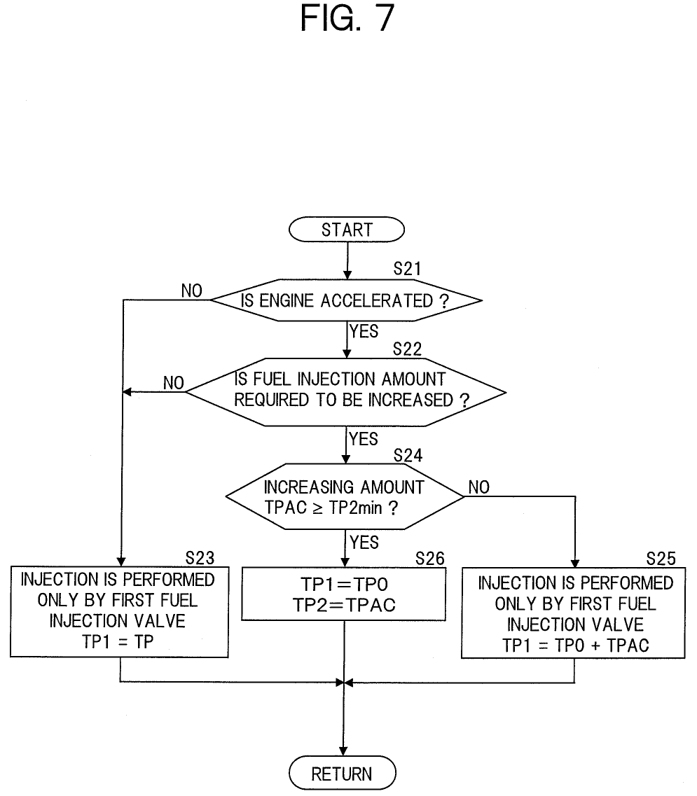

Further, in the above-mentioned system, at the time of the engine accelerating, first and second fuel injection valves 103 and 104 are used together. This fuel injection control at the time of the engine accelerating in a third embodiment will be described in accordance with a flowchart of FIG. 7.

In step S21, it is judged whether or not the engine is in an accelerated state. To be specific, this judgment is made based on whether or not a change rate ΔTVO (a change amount per unit time) of the throttle opening TVO and an engine load, for example, a change rate ATP of the fuel injection amount TP, a change rate ΔQ of an intake air flow amount Q, a change rate ΔPa of an intake pressure Pa downstream of the throttle valve and the like, are equal to or larger than judgment values (>0) thereof.

When it is judged that the engine is in the accelerated state, the process proceeds to step S22 where it is judged whether or not the fuel injection amount is required to be increased. Here, the requirement of fuel injection amount increase includes an interruption requirement during the fuel injection other than a requirement before the fuel injection according to the engine operating state.

In step S21, when it is judged that the engine is not in the accelerated state or in step S22, when it is judged that the fuel injection amount is not required to be increased, the process proceeds to step S23 where the fuel injection only by first fuel injection valve 103 is performed (TP1=TP).

In step S22, when it is judged that the fuel injection amount is required to be increased, the control process proceeds to step S24 where it is judged whether or not an increasing amount TPAC is equal to or larger than the lower limit injection amount TP2min at which the stable injection amount characteristic of second fuel injection valve 104 can be maintained.

In step S24, when it is judged that the increasing amount TPAC is smaller than the lower limit injection amount TP2min, since the injection of increasing amount TPAC by second fuel injection valve 104 cannot be stably performed, the control process proceeds to step S25 where a total required fuel amount obtained by adding the increasing amount TPAC to the basic injection amount TP0 is injected only by first fuel injection valve 103 (TP1=TP0+TPAC).

Further, in step S24, when it is judged that the increasing amount TPAC is equal to or larger than the lower limit injection amount TP2min, the process proceeds to step S26 where the basic injection amount TP0 is injected by first fuel injection valve 103 and the increasing amount TPAC is injected by second fuel injection valve 104 (TP1=TP0, TP2=TPAC).

Thus, at the time of the engine acceleration, the increasing amount TPAC is basically injected by second fuel injection valve 104, so that the increasing amount TPAC is introduced and supplied into combustion chamber 106 while being efficiently vaporized. On the other hand, the injection amount by first fuel injection valve 103 needs not to be increased, and therefore, the wall flow due to the fuel attachment to intake port 102, intake valve 105 or the like can be suppressed and accordingly, the increasing amount can be decreased, so that the fuel consumption can be improved, and also, the discharge amount of unburned fuel due to the wall flow can be reduced to thereby improve the exhausting performance.

Further, when the increasing amount TPAC is smaller than the lower limit injection amount TP2min, at which the injection of the increasing amount by second fuel injection valve 104 cannot stably take place, the injection by second fuel injection valve 104 is inhibited and the fuel injection is performed only by first fuel injection valve 103. Therefore, the required fuel amount can be reliably injected to thereby ensure the acceleration performance of the engine.

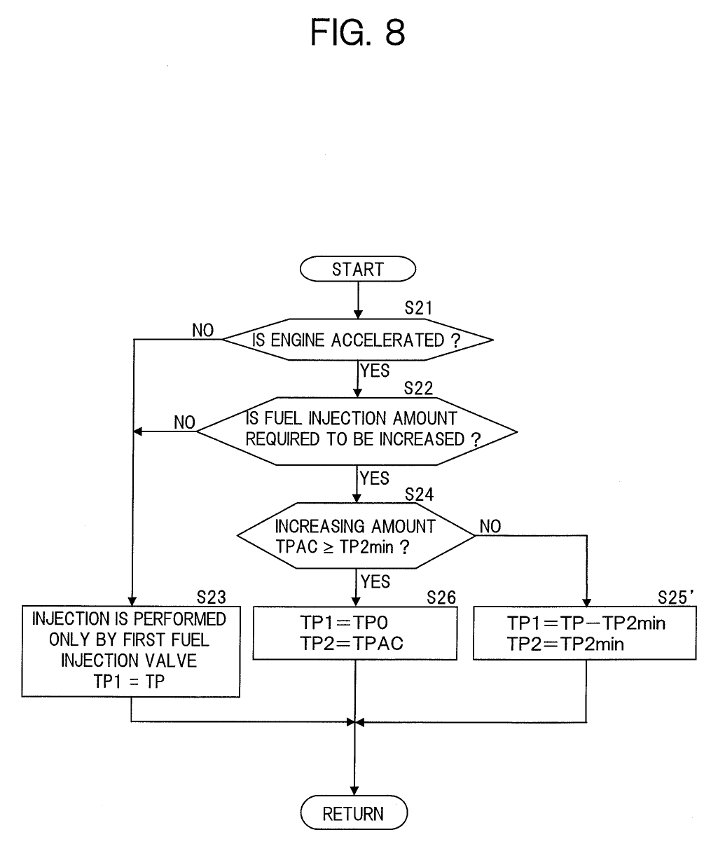

In the present embodiment, the configuration is such that when the increasing amount TPAC is smaller than the lower limit injection amount TP2min, the fuel injection is performed only by first fuel injection valve 103. However, as shown in a fourth embodiment of FIG. 8, a modified embodiment can be applied in which when the increasing amount TPAC is smaller than the lower limit injection amount TP2min, in step S25′, a fuel amount of the lower limit injection amount TP2min is injected by second fuel injection valve 104, and a fuel amount obtained by subtracting the lower limit injection amount TP2min from the total required injection amount TP is injected by first fuel injection valve 103 (TP1=TP−TP2min, TP2=TP2min).

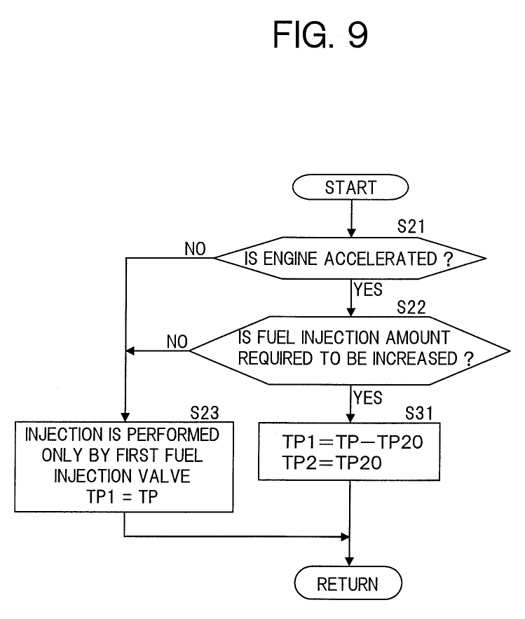

For further simplicity, as depicted by a fifth embodiment of FIG. 9, a modified embodiment can be applied in which when the fuel injection amount is required to be increased, in step S31, a given fixed fuel amount TP20 equal to or larger than the lower limit injection amount TP2min is injected by second fuel injection valve 104, and the remaining fuel injection amount is injected by first fuel injection valve 103 (TP1=TP−TP20, TP2=TP20).

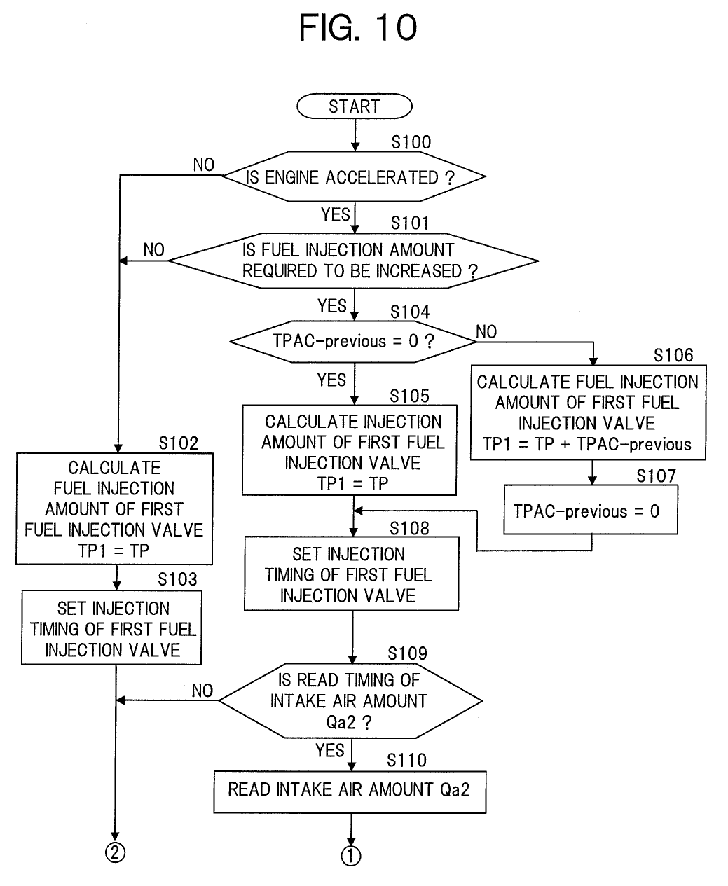

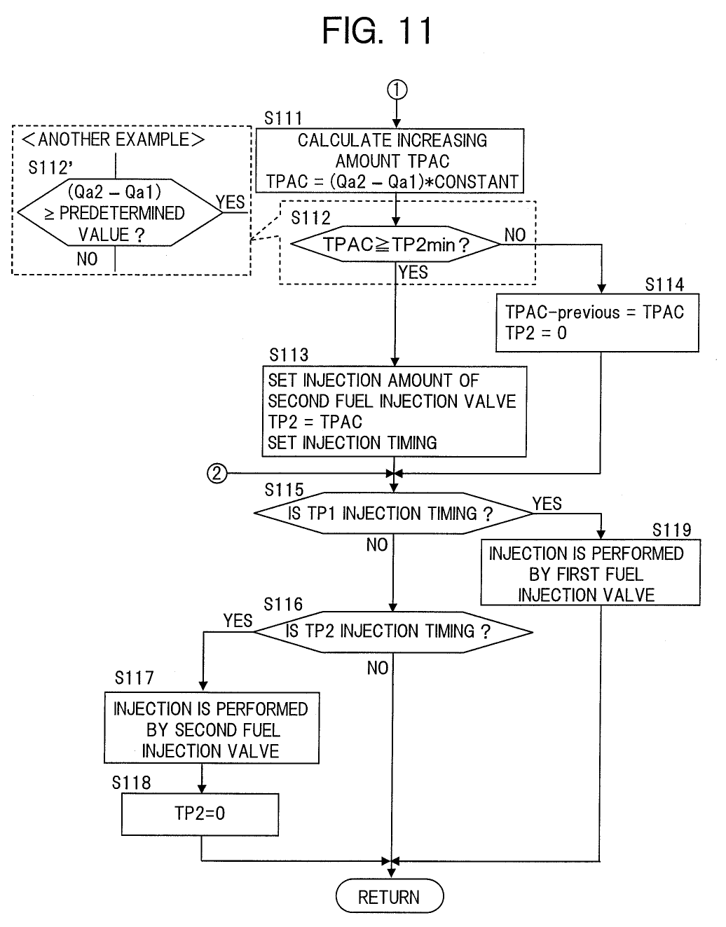

Next, a description of a sixth embodiment will be provided, based on flowcharts of FIG. 10 and FIG. 11. In this embodiment, the increasing amount TPAC to be injected by second fuel injection valve 104 is set according to a change amount of the intake air amount in computation timing for each of first and second fuel injection valves 103 and 104, while controlling the injection amounts and injection timing of first and second fuel injection valves 103 and 104 at the time of the engine acceleration.

In step S100 and step S101, similarly to step S21 and step S22, it is judged whether or not the engine is in the accelerated state, and it is judged whether or not the fuel injection amount is required to be increased.

Then, when it is judged that the engine is not in the accelerated state or when it is judged that the fuel injection amount is not required to be increased, the control process proceeds to step S102 where the basic injection amount TP0, which is calculated based on the intake air amount Qa1 detected at the time by air flow meter 122 and the engine rotating speed Ne detected at the time by rotating speed sensor 124, is corrected with an air-fuel ratio feedback correction coefficient set based on the air-fuel ratio detection value from the air-fuel ratio sensor (not shown in the figure), to calculate the fuel injection amount TP, and the calculated fuel injection amount TP is set as the fuel injection amount TP1 of first fuel injection valve 103.

In step S103, the fuel injection amount TP1 is converted into injection pulse width, and the injection timing of first fuel injection valve 103 is set based on the injection pulse width.

The injection timing is set so that the fuel is injected in an exhaust stroke for example, so that the fuel spray injected from first fuel injection valve 103 can be made to collide with a rear side of intake valve 105 head of which temperature becomes high due to the combustion of the internal combustion engine, to thereby promote the fuel vaporization with the valve heat.

Further, as the injection timing, injection termination timing is previously decided, and injection start timing is set to be changed according to the injection pulse width on the basis of the injection termination timing.

However, the injection timing of first fuel injection valve 103 is not limited to the exhaust stroke, and may be varied according to the engine operating conditions. Further, the injection timing thereof may be set so that the injection termination timing is changed according to the injection pulse width on the basis of the injection start timing.

In step S100, when it is judged that the engine is in the accelerated state and in step S101, that the fuel injection amount is required to be increased, the process proceeds to step S104 where it is judged whether or not a previous value “TPAC-previous” (to be described later) of the increasing amount is 0, and when it is judged that TPAC=0, in step S105, the injection amount TP1 of first fuel injection valve 103 is calculated to be set, similarly to step S102 as described above.

On the other hand, in step S106, when it is judged that TPAC is not 0, the fuel injection amount TP is added with the previous value (TPAC-previous) of the increasing amount, to be set as the final fuel injection amount TP1, and in step S107, the previous value (TPAC-previous) of the increasing amount, which has been added to the fuel injection amount TP, is reset to 0.

Then, in step S108, similarly to step S103 as described above, the injection timing of first fuel injection valve 103 is set.

In step S109, it is judged whether or not a predetermined timing for reading of a intake air amount, which is set as a given lapse of time after the fuel injection by first fuel injection valve 103 has been reached, and when it is judged that the predetermined read timing of the intake air amount has been reached, an intake air amount Qa2 is calculated in step 110.

The intake air amount Qa2 is employed for calculation of the injection amount of the increasing amount TPAC as described later, and is set as follows in order to inject the increasing amount TPAC in the intake stroke.

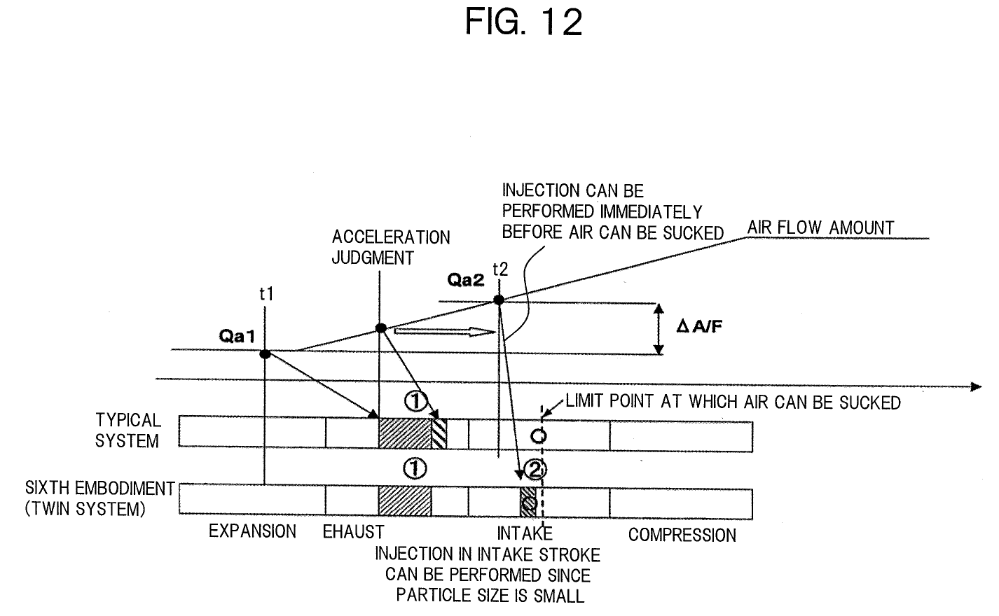

FIG. 12 is a time chart showing the read timing of the intake air amount Qa2.

In general, the setting is made such that the fuel injection amount based on the intake air amount Qa1 read at timing of t1 is calculated, and also, the increasing amount is calculated based on the intake air amount at the time when it is judged that the engine is in the accelerated state, so that the fuel injection amount calculated based on the intake air amount Qa1 and the injection amount of the increasing amount are added up to be injected in the exhaust stroke.

However, according to this setting, since it takes time from the injection timing until the air-fuel mixture is practically sucked into the combustion chamber, the fuel increasing amount cannot be set corresponding to an increase of the intake air amount due to the engine acceleration during the time. Therefore, there is a possibility that the increasing amount becomes deficient to lead the insufficient acceleration of the internal combustion engine and the degradation of the air-fuel ratio.

Further, in general, the fuel injection amount is controlled using a single fuel injection valve, and therefore, a fuel injection valve of large capacity capable of coping with a high rotation and high load time needs to be used. However, in the case where the fuel injection amount is required to be increased after the fuel injection termination, if only the increasing amount is injected, since the control resolution in a low injection amount region is low, it becomes hard to inject only the increasing amount with high precision. Therefore, the fuel injection amount based on the intake air amount Qa1 needs to be added with the increasing amount, to thereby be injected.

Contrary to the above, in the present embodiment, the injection timing, for example the injection termination timing, of second fuel injection valve 104 is previously set in order to inject the increasing amount TPAC in the intake stroke.

Then, the intake air amount Qa2 is read before a predetermined time which is previously set as a time necessary for computing the injection and setting the injection pulse amount based on the injection timing.

As a result, it is possible to set the injection amount of the increasing amount using the intake air amount in a state closer to the injection timing, so that the deviation between the computation timing of the injection amount and the injection timing can be made the small deviation to the extent that occurs due to a delay in the computation, and accordingly, it is possible to minimize the deviation in the injection amount due to the deviation between the computation timing and the injection timing as much as possible. Then, as a result that the deviation in the fuel injection amount can be made minimum, the accelerating performance and the exhausting performance can be maintained favorably.

Further, the fuel injection amount of the increasing amount is injected using second fuel injection valve 104 of which maximum injection amount is small and of which control resolution in the low injection region is high, and therefore, it is possible to inject the fuel injection amount of the increasing amount with high precision.

Incidentally, with regard to the injection timing in the intake stroke, a piston is not so fallen in the beginning of the intake stroke and a negative pressure in the combustion chamber is not developed sufficiently, and therefore, the flow rate of the intake air amount led into the combustion chamber is low. Even if the fuel is injected in such a state, there is a possibility that the sufficient vaporization cannot be promoted.

Further, in the latter half of the intake stroke, although the negative pressure in the combustion chamber is developed, there is a possibility that intake valve 105 is closed before the injection of the increasing amount is terminated. Further, there is a possibility that since a time until the air-fuel mixture is led into the combustion chamber to be ignited is short, the fluidity of the air-fuel mixture in the combustion chamber is insufficient and consequently, the combustibility cannot be improved.

Therefore, in the present embodiment, the injection termination timing of second fuel injection valve 104 which injects the increasing amount is set in the vicinity of 90° after intake top dead center (or about 120° after the intake valve starts to be opened), so that the fluidity of the air-fuel mixture in the combustion chamber is sufficiently made, while promoting the vaporization due to the development of the negative pressure in the combustion chamber and as a result, it is possible to improve the combustibility.

In step S111, the increasing amount TPAC is set based on the deviation between the read intake air amount Qa2 and the intake air amount Qa1 used for the calculation of the injection amount of first fuel injection valve 103 in step S105.

TPAC=(Qa2−Qa1)×constant

In the above formula, the constant is a conversion constant for converting the intake air amount into the injection amount, and is previously set.

Thus, by calculating the increasing amount TPAC based on the deviation between the intake air amounts, it is possible to set the fuel injection amount according to intake air amount states which are changed due to the acceleration of the engine.

In step S112, it is judged whether or not the calculated TPAC is equal to or larger than the lower limit injection amount TP2min at which the stable injection amount characteristic of second fuel injection valve 104 can be maintained.

When the increasing amount TPAC is smaller than the lower limit injection amount TP2min, the fuel injection cannot be performed with high precision even if the increasing amount TPAC is injected by second fuel injection valve 104, and therefore, in step S114, the increasing amount TPAC is stored in a memory as “TPAC-previous”.

Here, the stored “TPAC-previous” value is added to the fuel injection amount TP in step S106, to be set as the injection amount TP1 of first fuel injection valve 103.

Namely, “TPAC-previous” is injected by first fuel injection valve 103 at next injection timing. If the increasing amount TPAC is not injected, the fuel injection amount becomes leaner for the increasing amount TPAC, and therefore, the increasing amount TPAC is injected at the next injection timing of first fuel injection valve 103.

In such a case, since the increasing amount TPAC can be injected together with the fuel injection amount TP, the fuel injection can be performed with high precision, and also, since the fuel deficiency can be supplemented, the fuel leaning can be restored, so that the variation of air-fuel ratio or the power reduction can be suppressed as only temporary.

On the other hand, when it is judged that the increasing amount TPAC is equal to or larger than the lower limit injection amount TP2min, the process proceeds to step S113 where the increasing amount TPAC is set as the injection amount TP2 of second fuel injection valve 104, and also, as described in the above, the injection timing is set so that the fuel injection is performed at the predetermined timing in the intake stroke.

In step S115, it is judged whether or not the injection start timing of first fuel injection valve 103 has been reached, and if it is judged that the injection start timing (YES) has been reached, the control process proceeds to step 119 where the fuel injection is started.

In step S116, it is judged whether or not the injection start timing of second fuel injection valve 104 has been reached, and if it is judged that the injection start timing (YES) has been reached, the control process proceeds to step S117 where the fuel injection is started, and next, in step S118, the injection amount of second fuel injection valve 104 is reset.

Thus, the basic injection amount based on the engine operating state is injected in the exhaust stroke by first fuel injection valve 103, and the injection amount of the increasing amount TPAC is injected in the intake stroke by second fuel injection valve 104. Therefore, it is possible to perform the increase of fuel coping with the change in the intake air amount at the time of the engine accelerating, and also, the vaporization characteristic of fuel spray by second fuel injection valve 104 is high since the atomized particle size is small, and the control resolution in the low injection amount region is also high, so that it is possible to perform the fuel injection with high precision even if the increasing amount is small. Thus, the accelerating performance and the exhausting performance can be further improved favorably.

Further, since the intake air pressure is changed closer to the atmospheric pressure by the depression of an accelerator pedal at the time of the engine accelerating, the negative pressure in the combustion chamber is decreased and the intake air flow rate is decreased, so that the fuel is hard to be atomized. However, the fuel injected by second fuel injection valve 104 has the small particle size, and therefore, it is possible to atomize the fuel to thereby prevent the degradation of fuel vaporization.

Furthermore, since second fuel injection valve 104 is disposed on the side closer to the cylinder, it is possible to lead the fuel into the combustion chamber without delay, so that the air-fuel mixture state in the combustion chamber can be made favorable.

Still further, when the increasing amount TPAC is very small and is smaller than the lower limit injection amount TP2min of second fuel injection valve 104, the value of the increasing amount TPAC is stored to be held as “TPAC-previous” and is added to the injection amount of first fuel injection valve 103 at the next injection timing to be injected. Therefore, it is possible to restore the air-fuel ratio leaning or the power reduction which is caused as a result that the fuel has not been injected by second fuel injection valve 104.

Incidentally, in step S112, it is judged whether or not the increasing amount TPAC is equal to or larger than the lower limit injection amount TP2min of second fuel injection valve 104. However, in place of this process in step S112, as shown in step S112′, the increasing amount TPAC may be judged based on whether or not the deviation between the intake air amount Qa2 and the intake air amount Qa1 used for calculating the injection amount of first fuel injection valve 103, which is obtained in step S105, is equal to or larger than a predetermined value.

In such a case, since the increasing amount is set in proportion to the deviation, it is possible to set the predetermined value as the deviation equivalent to the lower limit injection amount TP2min.

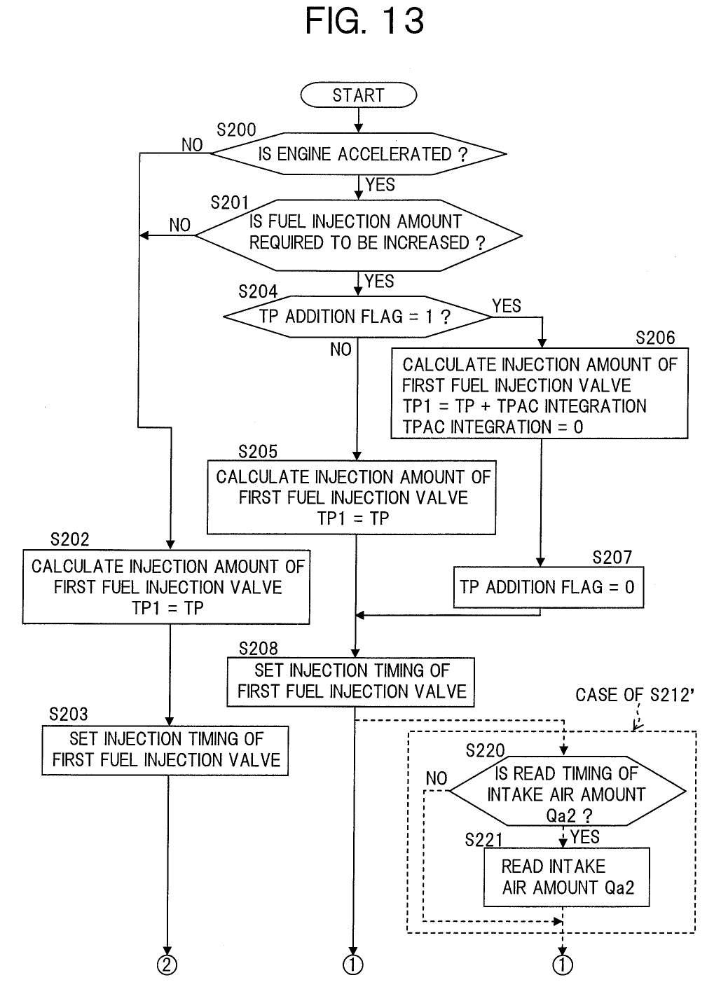

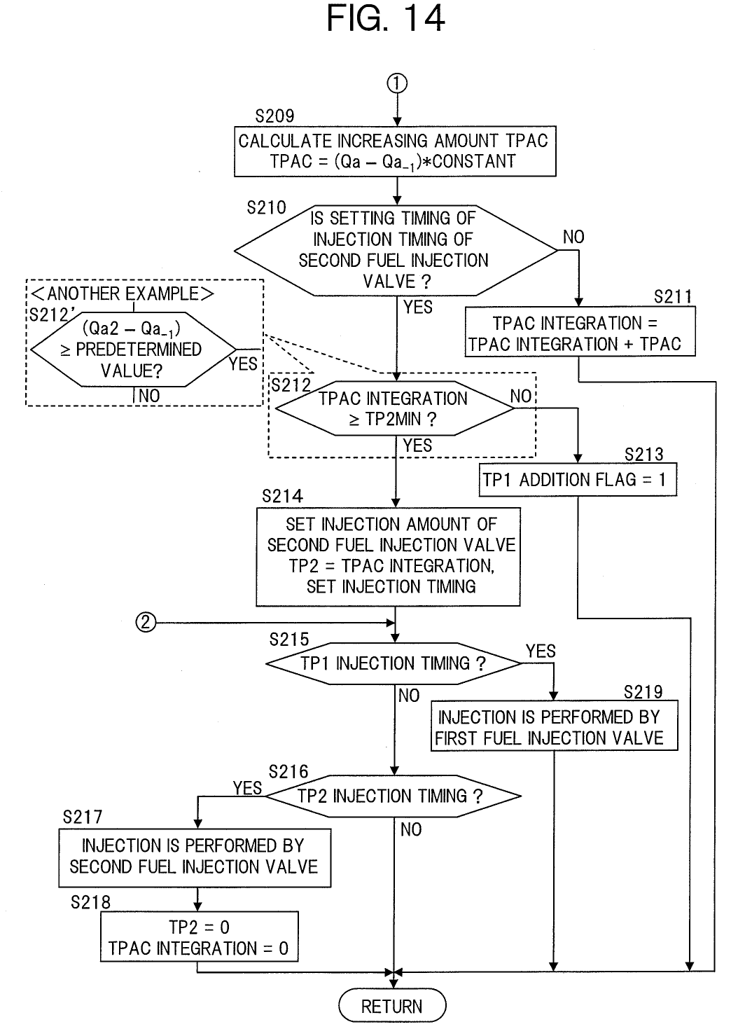

Next, a description of a seventh embodiment is provided, in which the increasing amount at the time of the engine accelerating is appropriately set with high precision depending on the acceleration state, in accordance with flowcharts of FIG. 13 and FIG. 14.

The seventh embodiment differs from the six embodiment in that the increasing amount TPAC is calculated at each sampling cycle (for example 10 ms) of air flow meter 122, based on the deviation between an intake air amount detection value of present time and an intake air amount detection value of previous time, to be integrated with the increasing amount TPAC of from the injection timing setting time of first fuel injection valve 103 to the second injection timing setting time thereof, and the integrated value thereof is set as the injection amount of second fuel injection valve 104.

Note, similarly to the sixth embodiment, in the present embodiment, when the integrated value is smaller than the lower limit injection amount TP2min of second fuel injection valve 104, the increasing amount is set as the injection amount of first fuel injection valve 103 at the next combustion time.

In the followings, only steps different from those of the sixth embodiment will be described.

In steps S200 and step S201, when it is judged that the fuel injection amount is required to be increased at the acceleration state, the process proceeds to step S204 where it is judged whether or not a TP addition flag is 1.

This TP addition flag is a flag set in the case where the increasing amount described later is added as the injection amount TP1 of first fuel injection valve 103, and by setting the flag at 1, the addition process is performed.

Then, when the TP addition flag is 1, in step S206, the integrated value of TPAC is added to the fuel injection amount TP to thereby set the injection amount TP1, and also, the integrated value of TPAC is reset, and further, in step S207, the TP addition flag is reset.

On the other hand, when the TP addition flag=0, the integrated value of TPAC being the increasing amount needs not to be added, and therefore, in step S205, the fuel injection amount TP is calculated by correcting the basic fuel injection amount TP0, which is calculated based on the intake air amount Qa1 detected by air flow meter 122 and the engine rotating speed Ne detected by rotating speed sensor 124, with the correction coefficient, such as the air-fuel ratio feedback correction coefficient or the like, to be set as the injection amount TP1 of first fuel injection valve 103.

Then, after the fuel injection amount TP1 is set, in step S208, the injection timing of first fuel injection valve 103 is set. This injection timing is set in the exhaust stroke, similarly to the sixth embodiment.

Thereafter, in step S209, the increasing amount TPAC is calculated based on the deviation between the intake air amount Qa detected at present time and the intake air amount Qa₋₁ detected at previous time.

TPAC=(Qa−Qa₋₁)×constant

In step S210, it is judged whether or not it is injection timing setting timing of second fuel injection valve 104, that is, “timing before the predetermined time previously set as the time necessary for computing the injection amount and setting the injection pulse from the second injection timing”, and if this judgment is NO, in step S211, the increasing amount TPAC is added to the integrated value of previous time, and the integrated value is updated until the injection timing setting timing.

On the other hand, the above judgment is YES, in step S212, it is judged whether or not the integrated value of TPAC up to the time is smaller than the lower limit injection amount TP2min of second fuel injection valve 104, and when the integrated value of TPAC is smaller than the lower limit injection amount TP2min, in step S213, the TP addition flag 1 is set at 1.

As a result, when the integrated value is smaller than the lower limit injection amount TP2min of second fuel injection valve 104, in step S206, it is possible to set the integrated value of TPAC as a portion of the injection amount of first fuel injection valve 103 at the next combustion time.

On the other hand, when the integrated value of increasing amount TPAC is equal to or larger than the lower limit injection amount TP2min of second fuel injection valve 104, in step S214, the integrated value is set as the injection amount TP2 of second fuel injection valve 104, and the injection timing is set in the intake stroke.

Then, in step S217, the fuel of injection amount TP2 is injected by second fuel injection valve 104, and thereafter, in step S218, the injection amount TP2 and the integrated value of TPAC are reset.

Incidentally, similarly to the sixth embodiment, in step S212, it may be judged whether or not the increasing amount TPAC is equal to or larger than the lower limit injection amount TP2min of second fuel injection valve 104. However, alternatively, as in step S212′ shown inside the dot lined frame, the increasing amount TPAC may be judged based on whether or not the deviation between the intake air amount Qa2 and the intake air amount Qa1 used for calculating the injection amount obtained in step S205 of first fuel injection valve 103 is equal to or larger than the predetermined value. In such a case, the processes (step S220 and step S221 in FIG. 13) similar to those in steps S109 and S110 of the sixth embodiment are added.

In order to realize the vehicle acceleration responsibility at the time of the engine accelerating without delaying in an accelerating operation by a driver, the detection value of the intake air amount Qa of the former half of the intake stroke may be used. However, if the fuel is injected in the former half of the intake stroke, there is a problem in that a time for heating to vaporize the fuel is deficient, and consequently, the fuel is not vaporized sufficiently. On the other hand, in the present embodiment, since the fuel spray by second fuel injection valve 104 has the small particle size, the fuel can be vaporized sufficiently even in a short time, and therefore, the above problem can be solved favorably.

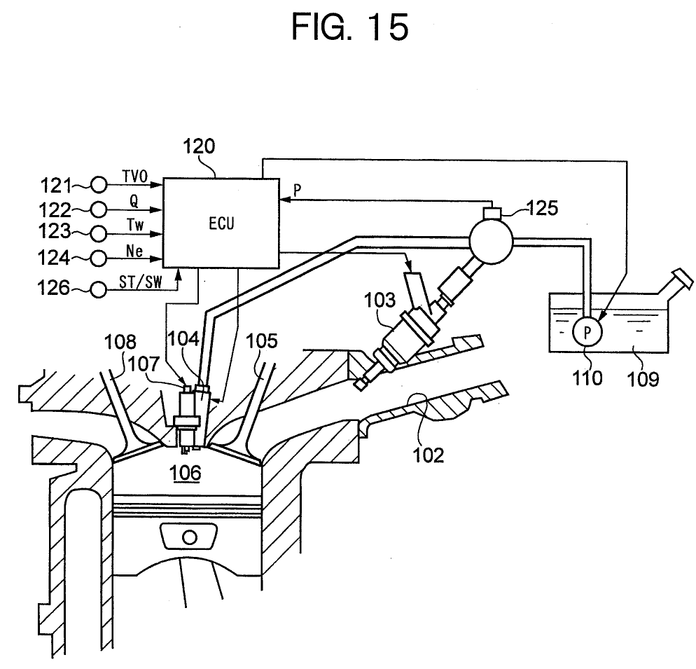

Further, as shown in FIG. 15, the present invention including the above each embodiments can be applied to a system in which second fuel injection valve 104 is attached to combustion chamber 106 to thereby directly inject the fuel to combustion chamber 106, and same functions and same effects can be achieved in the each embodiments. Further, since the atomized fuel is injected into the combustion chamber from second fuel injection valve 104, the wall flow is suppressed, and the fuel consumption and the exhausting performance at the changing-over time of the fuel injection valves and at the acceleration time can be improved.

The entire contents of Japanese Patent Application No. 2007-243909 filed on Sep. 20, 2007 and, a priority of which is claimed, are incorporated herein by reference.

While only selected embodiments have been chosen to illustrate and describe the present invention, it will be apparent to those skilled in the art from this disclosure that various changes and modifications can be made herein without departing from the scope of the invention as defined in the appended claims.

Furthermore, the foregoing description of the embodiments according to the present invention is provided for illustration only, and not for the purpose of limiting the invention as defined by the appended claims and their equivalents.

We claim:

1. An apparatus for controlling fuel injection of an internal combustion engine, comprising:
a first fuel injection valve arranged at an intake port and capable of exhibiting a predetermined spray property thereof;
a second fuel injection valve arranged on an intake air flow downstream side of the first fuel injection valve and capable of exhibiting a spray property having a vaporization characteristic higher than that of the first fuel injection valve;
an operating condition detector configured to detect operating state of the internal combustion engine; and
a control unit configured to implement setting of a fuel injection amount based on the engine operating state, controlling of the fuel injection valves which perform fuel injection according to the fuel injection amount, and determining of fuel injection amounts to be shared by the fuel injection valves, upon detecting of a condition such that the fuel injection are to be simultaneously performed by the first and second fuel injection valves, to thereby control each of the fuel injection valves based on the fuel injection amounts having been determined.

2. The apparatus according to claim 1, wherein the control unit comprises:
a valve deciding section configured to decide at least one fuel injection valve out of the fuel injection valves which is to perform the fuel injection, based on the operating state of the internal combustion engine;
a double injection period setting section configured to set a double injection period during which the fuel injection is performed by both of the first and second fuel injection valves for a predetermined period, when the fuel injection valve to perform the fuel injection is changed-over based on decision made by the valve deciding section;
a fuel injection amount setting section configured to set the fuel injection amount based on the operating state of the internal combustion engine, and during the double injection period, to further set fuel injection amounts to be shared respective by the fuel injection valves; and
a fuel injection controlling section configured to control the fuel injection valves based on the fuel injection amounts having been set.

3. The apparatus according to claim 2, wherein, during the double injection period, the fuel injection amount setting section varies the shares of fuel injection amounts of respective of the fuel injection valves in a tendency of gradually decreasing the fuel injection amount of the fuel injection valve which is to stop the fuel injection based on the changing-over, and of gradually increasing the fuel injection amount of the fuel injection valve which is to start the fuel injection, to thereby set the fuel injection amounts.

4. The apparatus according to claim 3, wherein the fuel injection amount setting section sets the shares of the fuel injection amounts of respective of the fuel injection valves during the double injection period, thereby prolonging the double injection period as a temperature of the internal combustion engine is lower.

5. The apparatus according to claim 2, wherein the valve deciding section decides the at least one fuel injection valve out of the fuel injection valves, which is to perform the fuel injection, in a manner such that the fuel injection is performed only by the second fuel injection valve at a cranking time, and changing-over to the fuel injection by the first fuel injection valve is commenced after a predetermined time has elapsed from completion of the cranking.

6. The apparatus according to claim 5, wherein the valve deciding section sets the predetermined time to be more prolonged as the engine temperature is lower.

7. The apparatus according to claim 2, wherein the valve deciding section decides the at least one fuel injection valve out of the fuel injection valves, which is to perform the fuel injection, in a manner such that the fuel injection by respective of the first and second fuel injection valves is performed in a region equal to or larger than a lower limit of injection amount at which linearity of characteristics of the fuel injection amounts of the respective fuel injection valves relative to valve opening times of the respective fuel injection valves is maintained.

8. The apparatus according to claim 1, wherein the control unit comprises:
an accelerated state detecting section configured to detect an engine accelerated state based on the engine operating state;
a fuel injection amount setting section configured to set the fuel injection amount based on the engine operating state, and sets, when the accelerated state is detected, a main portion of the set fuel injection amount as the fuel injection amount by the first fuel injection valve while setting an increasing amount correction portion for acceleration as the fuel injection amount by the second fuel injection valve; and
a fuel injection controlling section configured to control each of the fuel injection valves based on the fuel injection amounts having been determined.

9. The apparatus according to claim 8, wherein the fuel injection amount setting section sets the fuel injection amount to be injected by the second fuel injection valve when the accelerated state is detected, based on a deviation between an intake air amount at a time when the fuel injection amount by the first fuel injection valve is computed and an intake air amount at a later time than the above time, when the fuel injection amount by the second fuel injection valve is computed.

10. The apparatus according to claim 8, wherein the fuel injection amount setting section calculates the increasing amount correction portion for acceleration based on the deviation between a newestly detected intake air amount and a one time previously detected intake air amount, and integrates the increasing amount correction portion calculated at each periodic time of detection of the intake air amount from a time when the injection amount of the first fuel injection valve is computed until a later time than the above time, when the injection amount of the second fuel injection valve is computed, to thereby set the integrated value as the fuel injection amount of the second fuel injection valve.

11. The apparatus according to claim 8, wherein, when the set fuel injection amount by the second fuel injection valve is smaller than a lower limit injection amount at which the linearity of the characteristic of the fuel injection amount relative to the valve opening time is maintained, the fuel injection amount setting section adds the fuel injection amount by the second fuel injection valve to the fuel injection amount computed for a next time of the first fuel injection valve, thereby setting the added fuel injection amount as a next time fuel injection amount by the first fuel injection valve.

12. The apparatus according to claim 1, wherein the second fuel injection valve is disposed on the intake port in the vicinity of an intake valve, to implement injection of the fuel during an intake stroke via the intake valve.

13. The apparatus according to claim 1, wherein the second fuel injection valve is disposed to be capable of directly injecting the fuel into a combustion chamber.

14. An apparatus for controlling fuel injection of an internal combustion engine, comprising:
a first fuel injection valve arranged at an intake port and capable of exhibiting a predetermined spray property thereof;
a second fuel injection valve arranged on an intake air flow downstream side of the first fuel injection valve and capable of exhibiting a spray property having a vaporization characteristic higher than that of the first fuel injection valve;
operating condition detecting means for detecting engine operating state; and
controlling means for controlling setting of a fuel injection amount based on the engine operating state, operation of each of the fuel injection valves so as to perform fuel injection based on the fuel injection amount, and setting, when it is detected that the fuel injection are to be simultaneously performed by each of the fuel injection valves, of the fuel injection amounts to be shared by the fuel injection valves, thereby eventually controlling the fuel injection valves based on the fuel injection amounts having been determined.

15. A method of controlling fuel injection by fuel injection valves of an internal combustion engine, comprising the steps of:
performing the fuel injection into an intake port by a first fuel injection valve having a predetermined spray property, according to a requirement from the internal combustion engine;
performing the fuel injection to an intake air flow downstream side of the first fuel injection valve by a second fuel injection valve having a spray property having a vaporization characteristic higher than that of the first fuel injection valve;
detecting engine operating state;
setting a fuel injection amount based on the engine operating state;
controlling each of the fuel injection valves to perform the fuel injection based on the fuel injection amount having been set; and
setting, upon detection of a condition that the fuel injection should be simultaneously performed by the fuel injection valves, respectively, fuel injection amounts to be shared by respective of the fuel injection valves, thereby controlling each of the fuel injection valves based on the fuel injection amounts having been determined.

16. The method according to claim 15, wherein the step of controlling each of the fuel injection valves comprises the steps of:
deciding at least one fuel injection valve out of the fuel injection valves, which is to perform fuel injection, based on the engine operating state;
setting a double injection period during which the fuel injection is performed by both of the fuel injection valves for a predetermined period, when the fuel injection valve having been decided to perform the fuel injection is changed-over to a different one of the fuel injection valves;
setting the fuel injection amount based on the engine operating state, and during the double injection period, setting the fuel injection amounts to be shared by respective of the fuel injection valves; and
controlling each of the fuel injection valves based on the fuel injection amounts having been determined.

17. The method according to claim 16, wherein the step of setting the fuel injection amount carries out setting of the fuel injection amount by varying the shares of fuel injection amounts of each of the fuel injection valves in such a manner that, during the double injection period, the fuel injection amount of the fuel injection valve which is to be stopped based on the changing-over due to the deciding step, is gradually decreased while the fuel injection amount of the fuel injection valve which is to start the fuel injection is gradually increased.

18. The method according to claim 17, wherein the step of setting the fuel injection amount sets the shares of the fuel injection amounts of respective of the fuel injection valves during the double injection period, thereby prolonging the double injection period as the engine temperature is lower.

19. The method according to claim 16, wherein the step of deciding the fuel injection valve decides the fuel injection valve which is to perform the fuel injection, in a manner such that the fuel injection is performed only by the second fuel injection valve at a cranking time, and changing-over to the fuel injection by the first fuel injection valve is commenced after a predetermined time has elapsed from completion of cranking of the internal combustion engine.

20. The method according to claim 15, wherein the step of controlling each of the fuel injection valves comprises the steps of:
detecting an engine accelerated state based on the engine operating state;
setting the fuel injection amount based on the engine operating state in a manner such that when the accelerated state is detected, a main portion of the set fuel injection amount is set as the fuel injection amount by the first fuel injection valve while an increasing amount correction portion for acceleration is set as the fuel injection amount by the second fuel injection valve; and
controlling each of the fuel injection valves based on the set fuel injection amounts.
